(19) United States
(12) Patent Application Publication
(10) Pub. No.: US 2019/0329739 A1
(43) Pub. Date: Oct. 31, 2019

(54) BICYCLE TIRE MAINTENANCE SYSTEM

(71) Applicants: Cameron Hedrick, Indianapolis, IN (US); Benjamin L. Miller, Indianapolis, IN (US); Shawn Parks, Indianapolis, IN (US); Alan C. Harris, Indianapolis, IN (US)

(72) Inventors: Cameron Hedrick, Indianapolis, IN (US); Benjamin L. Miller, Indianapolis, IN (US); Shawn Parks, Indianapolis, IN (US); Alan C. Harris, Indianapolis, IN (US)

(21) Appl. No.: 15/966,498

(22) Filed: Apr. 30, 2018

(51) Int. Cl. B60S 5/04; B60C 23/00; B60C 29/06

(52) U.S. Cl. CPC B60S 5/043; B60C 29/066; B60C 23/001

(57) ABSTRACT

A system for regulating pressure in one or more vessels by adapting a fluid input to receive a fluid from a fluid source such as an air compressor at a constant pressure. At least one fluid outlet assembly is used to attach the system to a vessel such as a bike tire, ball, or car tire. At least one controllable valve is used to couple the fluid outlet assembly to the fluid input, the valve is controllable to pulsate air going through it, check the new pressure in the vessel, and either continue to increase pressure in the vessel, decrease pressure, or stop inflating. A pressure sensor corresponding to a fluid outlet assembly adaptable to provide pressure values from each vessel to a controller. The controller receives at least one desired pressure input, compares that value to the pressure value from the at least one pressure sensor, and selectively energizes the controllable valve to adjust the pressure in the corresponding vessel until the pressure within the vessel is equal to the desired pressure.

### TECHNICAL FIELD

The present application relates to a bicycle tire maintenance system, and more particularly to a system for storing, monitoring, and maintaining proper air pressure in bicycle tires.

### BACKGROUND

This section introduces aspects that may help facilitate a better understanding of the disclosure. Accordingly, these statements are to be read in this light and are not to be understood as admissions about what is or is not prior art.

The field of bicycle storage systems has many variations of mounts that will hold a bicycle in a convenient location to maximize the use of available space in a garage or other storage area. Various methods of inflating tires ranging from a traditional hand pump, CO₂ cartridges, or air compressors are also known in the art. One thing that is not available is a method of regulating the pressure of a bicycle tire that does not require the dust cap to be removed. The purpose of the dust cap is to prevent dirt and other debris from entering the valve stem causing the valve to fail due to being jammed open or closed. Sometimes the threads on the valve stem can see corrosion, making it difficult to get the dust cap off if the bicycle has not been serviced in some time. When this happens, it is possible to crack the plastic dust caps and lose the protection that they provide to the valve stem. Furthermore, the extra steps of having to remove the dust cap to insert air into the valve and remember to put the dust cap back onto the valve after insertion places inconvenience on the user.

Current bicycle mounts provide a good method of storing said bicycle out of the way when not in use. However, when a bicycle is stored for long periods of time, the tires can leak. This is especially true when a bicycle is stored under variable climate conditions. When a person wants to go and use their bicycle, especially for the purpose of transportation, it is frustrating to realize that the user has to go and find a method to inflate the flat tires before safely riding.

There is, therefore an unmet need for a novel system for storing a bicycle that can ensure that the bicycle tires are properly pressurized and ready for use each and every day, which does not require the plastic dust cap to be removed in order to access the valve stem.

### SUMMARY

A system for regulating pressure in one or more vessels by adapting a fluid input to receive a fluid from a fluid source such as an air compressor at a constant pressure. At least one fluid outlet assembly is used to attach the system to a vessel such as a bike tire, ball, or car tire. At least one controllable valve is used to couple the fluid outlet assembly to the fluid input, the valve is controllable to pulsate air going through it, check the new pressure in the vessel, and either continue to increase pressure in the vessel, decrease pressure, or stop inflating. A pressure sensor corresponding to a fluid outlet assembly adaptable to provide pressure values from each vessel to a controller. The controller receives at least one desired pressure input, compares that value to the pressure value from the at least one pressure sensor, and selectively energizes the controllable valve to adjust the pressure in the corresponding vessel until the pressure within the vessel is equal to the desired pressure.

### BRIEF DESCRIPTION OF DRAWINGS

FIG. 1 is a block diagram regarding the pressure system.

FIG. 2 is an isometric view of a bicycle mount assembly.

FIG. 3 is an isometric view of a tire hook and pump control assembly.

FIG. 4 is an exploded view of a fluid outlet assembly and valve stem.

FIG. 5 is an exploded cross section view of the fluid outlet assembly and valve stem.

FIG. 6 is an assembly view of a bicycle on the bicycle mount.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure the term “about” can allow for a degree of variability in a value or range, for example, within 10%, within 5%, or within 1% of a stated value or of a stated limit of a range.

In the present disclosure the term “substantially” can allow for a degree of variability in a value or range, for example, within 90%, within 95%, or within 99% of a stated value or of a stated limit of a range.

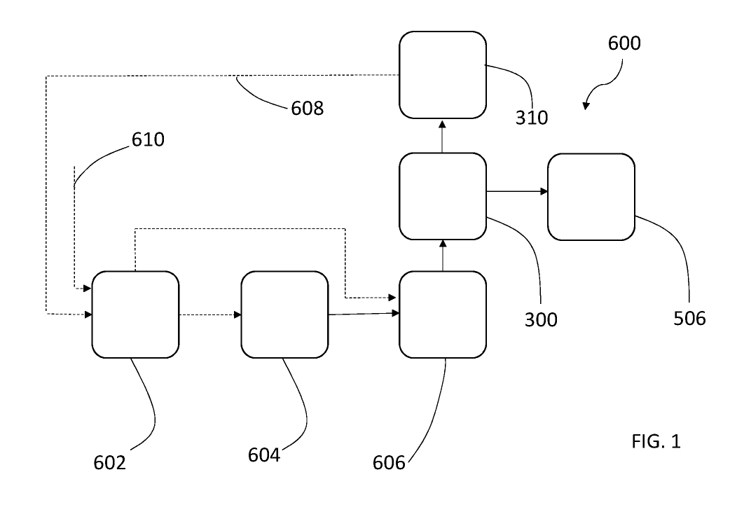

The embodiment in FIG. 1 shows a controller 602, being arranged in a way to accept multiple inputs and multiple outputs. A first set of inputs 610 is at least one desired pressure that is set by a user. The user would be able to set a single desired pressure to be applied for all of the at least one fluid outlet assemblies 300 or set individual desired pressures for each of the corresponding fluid outlet assemblies 300. A second set of inputs 608 is a corresponding pressure value from each fluid outlet assembly 300. The controller 602 compares the corresponding values from the first set of inputs 610 to the second set of inputs 608, if the second set of inputs is significantly less than or significantly more than the desired pressure, the controller 602 activates a fluid source 604 and/or opens at least one controllable valve 606 to direct the fluid into or out of the fluid outlet assembly 300 that was determined to be of high or low pressure. The controller 602 activates the controllable valve 606 in a pulsating method with a duty cycle of about 1% to about 10%. Between each pulse, the controller 602 is comparing the pressure value to the desired pressure and deciding whether to continue pulsations. Pulsating the controllable valve 606 is only one method of regulating the pressure from the fluid source 604 to the pressure vessel 506, other methods of regulating pressure from a source are known to people having ordinary skill in the art.

The at least one controllable valve 606 is arranged to accept a signal from the controller 602 that energizes a solenoid (not shown). When the solenoid (not shown) is energized, magnetic forces open the controllable valve 606 and allow fluid to pass through. The system can consist of many controllable valves 606 to increase the number of fluid outlets being controlled by the system.

An at least one pressure sensor 310 is coupled to the fluid outlet assembly 300 and sends the pressure value to the controller 602. In one embodiment the pressure sensor 310 can be housed within the fluid outlet assembly 300. In a second embodiment the pressure sensor 310 can be housed approximately adjacent to the controllable valve 606.

The fluid outlet assembly 300 is coupled to the controllable valve 606 by means of a flexible hose 110, hard fluid line, or other means known to a person having ordinary skill in the art. The fluid outlet assembly 300 is adaptable to couple the fluid source 604 to a variety of vessels 506. The vessels 506 could be any of bike tires, automobile tires, athletic balls, or other pressurized vessels that may lose pressure over time.

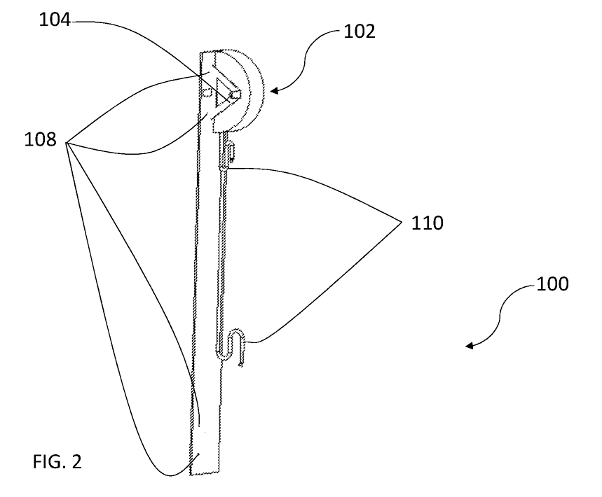

FIG. 2 through FIG. 6 specifically relate to one embodiment of the maintenance system for pressure vessels 506. FIG. 2 is an isometric view of a bicycle mount 100. A tire hook 104 is coupled to the bicycle mount 100. The bicycle mount 100 is held to a wall stud (not shown) by means of at least one fastener 108 or secured to the ground if a horizontal storage position is desired. The fastener(s) 108 can consist of any method of hanging or attaching brackets to a wall stud, concrete, or brick surface known to a person having ordinary skill in the art. A pump control assembly 102 comprises a fluid source 604, a controllable valve 606, and a controller 602. Coming from the pump control assembly 102 are a plurality of flexible hoses 110. Each flexible hose 110 couples the fluid source 604 to the controllable valve 606, then couples the controllable valve 606 to the fluid outlet assembly 300. This specific embodiment shows a fluid outlet assembly 300 that mechanically couples the fluid source 604 to a valve cap 418 that is coupled to the valve stem 514 of a bicycle.

The valve cap 418 is essentially cylindrical having a threaded inner diameter 426 for about 50% to about 90% of the length. On the opposite end from the threads, the valve cap 418 has a circular opening 428. The circular opening has a diameter less than the inner diameter of the valve cap 418 such that a shelf 424 is formed. On the outer perimeter of the valve cap 418 there is a lip 414 to provide an engagement point for attachment to the fluid output assembly 300.

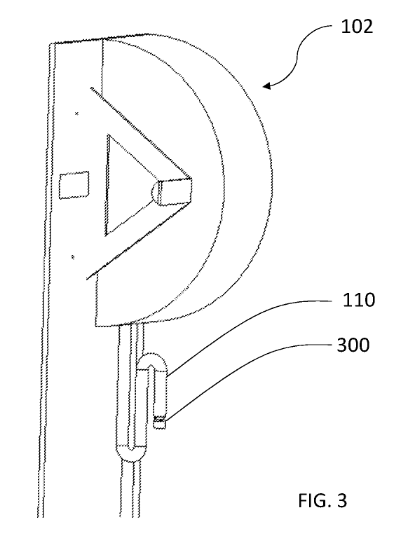

FIG. 3 is a close-up view of the pump control assembly 102. The at least one flexible hose 110 is coupled to the fluid outlet assembly 300 by means of a crimp fit, press fit, hose clamp, or other means known to a person having ordinary in the skill art. The fluid outlet assembly 300 removes the requirement for a user to remove the protective tire cap (not shown) commonly found on a valve stem 514. The protective tire cap (not shown) prevents dirt from entering the valve stem 514 which would prevent the Shrader or Presta valve from opening or closing properly.

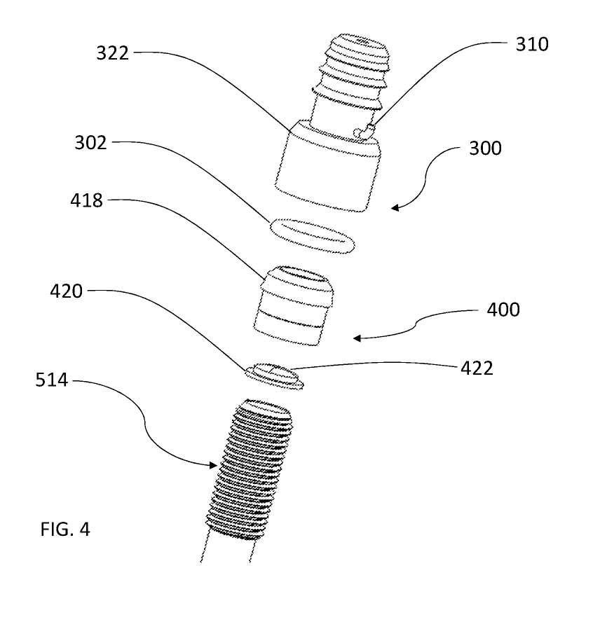

FIG. 4 is an exploded view of the fluid outlet assembly 300. A valve cap assembly 400 replaces the standard tire valve cap (not shown). The valve cap assembly 400 comprises a valve cap 418 and a valve cap gasket 420. The valve cap gasket 420 is mechanically held in place by screwing the valve cap 418 onto the valve stem 514, which compresses the valve cap gasket 420 between the valve stem 514 and the shelf 424 in the valve cap 418. The valve cap gasket 420 is flexible and has a top surface 422. The top surface 422 has at least one slot perpendicular to the axis of rotation of the valve cap gasket 420. The slot in the top surface 422 is adaptable to be closed when not engaged by the fluid outlet assembly 300 and open to allow fluid to pass through when engaged. An O-ring 302 is housed within the inner diameter of a inflation tool housing 322 to prevent loss of air when the fluid outlet assembly 300 is engaged. The inflation tool housing has an assess port for the pressure sensor 310.

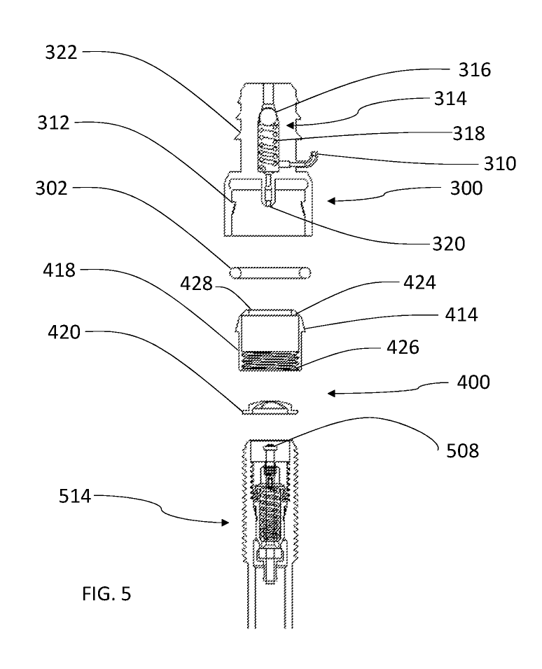

FIG. 5 is an exploded cross-section view of the fluid outlet assembly 300 of the current embodiment. The fluid outlet assembly 300 further comprises a check valve 314 comprising a spring 318 and a check valve ball 316. When the controller 602 is not activating the fluid source 604, the check valve 314 prevents air from leaking out of the vessel 506. In this embodiment the vessel 506 is a bicycle tire. When the fluid source 604 is activated, the fluid pressure within the flexible hose 110 compresses the spring 318, allowing air to enter the vessel 506. A valve activator 320 is essentially coaxial with the inflation tool housing 322. The valve activator 320 is arranged to deform the top surface 422, depress a valve stem pin 508 commonly found in Schrader style valve stems 514 commonly used by a person having ordinary skill in the art, and to have an opening to allow fluid to exit the fluid outlet assembly 300.

The inflation tool housing 322 is mechanically coupled to the valve cap assembly 400 in this embodiment by means of a snap feature 312. The snap feature 312 has an interference fit with the lip feature 414 on the valve cap 418. In another embodiment, the snap feature could be replaced by a magnet, and the lip feature 414 be replaced by a magnetic flange to couple the inflation tool housing 322 to the valve cap assembly 400.

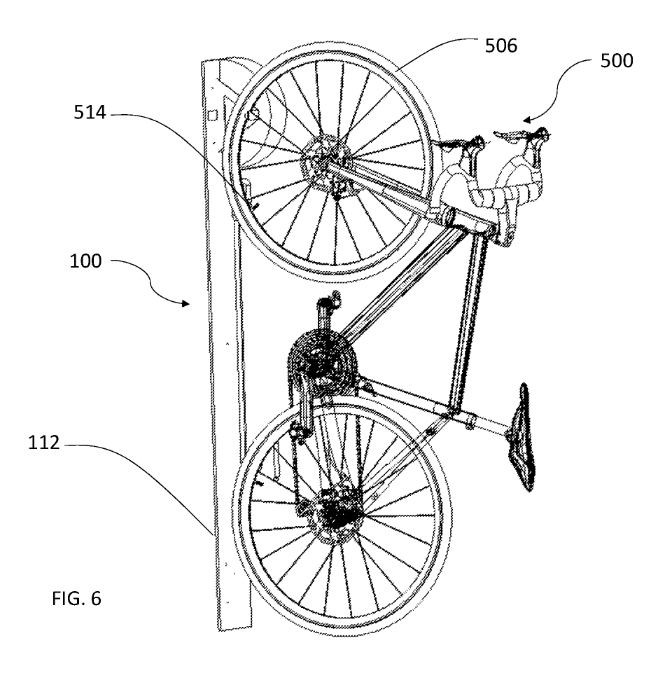

FIG. 6 illustrates how a bicycle 500 would be orientated on the bicycle mount 100. The bicycle tire 506 is mechanically held to the bicycle mount 100 by means of the tire hook 104. Gravity puts a force on the bicycle 500, pulling it down and away from the tire hook 104. The force from gravity ensures the bicycle tire 506 is always in contact with the tire hook 104 during storage. The bicycle mount 100 has a scuff plate 112 that prevents the wall or floor (not shown) from being scuffed by the bicycle tire 506 and leaving undesirable marks. After mounting the bicycle 500, the flexible hoses 110 would be attached to the valve stem 514 on both the front and rear bicycle tires. The fluid outlet assembly 300 can be used to couple the flexible hose 110 to the valve stem 514.

In alternative embodiments a user could remove the standard valve cap (not shown) and connect the air hose using standard methods known to a person having ordinary skill in the art. The fluid outlet assembly 300 has been shown in one embodiment regarding the maintenance of bicycle tires. Many other embodiments are possible by modifications to the inflation tool housing 322. One example of this would be to adapt the inflation tool housing 322 to have a needle commonly used by a person having ordinary skill in the art to inflate athletic balls such as basketballs, footballs, etc. Various other modifications could be made to the inflation tool housing 322 to couple the fluid outlet assembly 300 to other styles of valves or vessels known to a person having ordinary skill in the art.

Those skilled in the art will recognize that numerous modifications can be made to the specific implementations described above. The implementations should not be limited to the particular limitations described. Other implementations may be possible.

1. A system for regulating pressure in one or more vessels, comprising:
a fluid input adaptable to receive a fluid from a fluid source at a first pressure;
at least one fluid outlet assembly;
at least one controllable valve adaptable to couple the at least one fluid outlet assembly to the fluid input;
at least one pressure sensor corresponding to each of the at least one fluid outlet assembly adaptable to provide pressure values from a corresponding vessel;
a controller adaptable to i) receive at least one desired pressure, ii) receive pressure value from the at least one pressure sensor; and iii) selectively energize the at least one controllable valve to adjust the pressure in the corresponding vessel to the at least one desired pressure.

2. A valve cap assembly, comprising;
a valve cap having a cylindrical body with a threaded inner diameter for about 50% to about 90% of the length of the body, and a top end adaptable to receive a fluid input; and
a valve cap gasket having a top surface having at least one slot adaptable to accept an inflation tool assembly, wherein the combination of the valve cap and valve cap gasket prevent solid debris from entering a valve stem.

3. The apparatus of claim 2 wherein the inflation tool assembly is further comprising:
an inflation tool housing, having a valve activator, wherein said inflation tool housing can be coupled to the valve cap; and
an O-ring seated within an inner diameter of the inflation tool housing; and

4. The apparatus of claim 3, further comprising a pressure sensor adaptable to send pressure values from a corresponding pressure vessel to a controller adaptable to i) receive at least one desired pressure, ii) receive pressure value from the at least one pressure sensor; and
iii) selectively energize at least one controllable valve to adjust the pressure in the corresponding vessel to the at least one desired pressure, wherein the controllable valve couples a fluid input receiving a fluid from a fluid source at a first pressure to the inflation tool assembly.

5. The apparatus of claim 3, wherein the inflation tool housing is coupled to the valve cap by means of at least one clip or snap feature.

6. The apparatus of claim 3, wherein the inflation tool housing is coupled to the valve cap by means of a magnetic force.

7. A method for regulating pressure in one or more vessels, comprising:
a. inputting one or more desired pressure values corresponding to one or more pressure vessels into a controller;
b. coupling at least one fluid outlet assembly to the corresponding one or more pressure vessels;
c. measuring pressure values from the one or more pressure vessels;
d. providing the measured pressure values to the controller;
e. comparing said measured pressure values to the corresponding one or more desired pressure values;
f. directing flow to or from the one or more pressure vessels of a pressurized fluid in response to the comparison by selectively energizing one or more controllable valves corresponding to the one or more pressure vessels until the one or more measured pressure values are about equal to the corresponding one or more desired pressure values; and
g. periodically comparing the one or more measured pressure values to the corresponding one or more desired pressure values and repeating step c-f.
